(19) United States
(12) Patent Application Publication
(10) Pub. No.: US 2026/0147291 A1
(43) Pub. Date: May 28, 2026

(54) IMAGE FORMING APPARATUS

(71) Applicant: KYOCERA Document Solutions Inc., Osaka (JP)

(72) Inventors: Teruhiko NAGASHIMA, Osaka (JP); Kei WAKAYAMA, Osaka (JP)

(73) Assignee: KYOCERA Document Solutions Inc., Osaka (JP)

(21) Appl. No.: 19/389,991

(22) Filed: Nov. 14, 2025

(30) Foreign Application Priority Data
Nov. 22, 2024 (JP) 2024-203609

(51) Int. Cl. G03G 15/08; G03G 15/01; G03G 21/16

(52) U.S. Cl. CPC G03G 15/0886; G03G 15/0121; G03G 15/0189; G03G 15/0875; G03G 21/1633; G03G 21/1647; G03G 2221/1654

(57) ABSTRACT

An image forming apparatus includes a main body, a container and a cover. The container includes a supply port, a shutter and a seal member which seals a gap between an outer edge portion of the supply port and the shutter. The image forming apparatus includes a shutter opening/closing mechanism. The shutter includes a shutter engagement portion, and the shutter opening/closing mechanism includes a first engagement portion. When the cover reaches a closed position, the first engagement portion makes contact with the shutter engagement portion from the inner side of the main body to cause the shutter to slide from a blocking position toward an opening position.

### INCORPORATION BY REFERENCE

This application is based upon and claims the benefit of priority from the corresponding Japanese Patent Application No. 2024-203609, filed on Nov. 22, 2024, the entire contents of which are incorporated herein by reference.

### BACKGROUND

The present disclosure relates to an image forming apparatus including a container which stores a toner.

A conventional image forming apparatus uses a toner to perform printing. The toner is stored in a container. The container includes a supply port, and causes the toner to flow from the supply port to supply the toner to a development device.

### SUMMARY

An image forming apparatus according to an aspect of the present disclosure includes a main body, a container and a cover. Inside the main body, a development device that develops an electrostatic latent image into a toner image is disposed. The container is removably fitted into the main body, and stores a toner supplied into the development device. The cover is supported turnably around a predetermined axis orthogonal to an up/down direction with respect to the main body, includes a fitting region into which the container is fitted and is displaceable between an open position where the cover is turned around the predetermined axis to expose the container in the fitting region to an outside of the main body and a closed position where the container in the fitting region is fitted inside the main body. The container includes a supply port, a shutter and a seal member. The supply port is opened downward in a state where the container is fitted inside the main body to cause the toner to flow to the development device. The shutter is slidable in a second direction orthogonal to a first direction, the first direction being a direction in which the supply port is opened, includes an opening that penetrates in the first direction and is displaceable between a blocking position where the shutter slides in the second direction to block the supply port and an opening position where the supply port overlaps the opening in the first direction. The seal member seals a gap between an outer edge portion of the supply port and the shutter in the first direction. In a state where the cover inside which the container is fitted is in the open position, the shutter is held in the blocking position whereas in a state where the cover inside which the container is fitted is in the closed position, the shutter is held in the opening position. The image forming apparatus further includes a shutter opening/closing mechanism that is disposed inside the main body. The shutter includes a shutter engagement portion that protrudes in the first direction. The shutter opening/closing mechanism includes a first engagement portion. When the cover is turned from the open position to reach the closed position, the first engagement portion makes contact with the shutter engagement portion from an inner side of the main body to cause the shutter to slide from the blocking position toward the opening position in the second direction.

### BRIEF DESCRIPTION OF THE DRAWINGS

FIG. 1 is a perspective view of an image forming apparatus according to an embodiment;

FIG. 2 is a perspective view in a state where one of outer covers in the image forming apparatus shown in FIG. 1 is in an open position;

FIG. 3 is a schematic view showing the internal configuration of the image forming apparatus according to the embodiment;

FIG. 4 is a schematic view of an image formation unit in the image forming apparatus shown in FIG. 3 and an area around the image formation unit;

FIG. 5 is a perspective view of a container which is fitted into the main body of the image forming apparatus according to the embodiment;

FIG. 6 is a perspective view of the container which is fitted into the main body of the image forming apparatus according to the embodiment;

FIG. 7 is a perspective view of the container which has been fitted into the outer cover in the image forming apparatus according to the embodiment and an area around the container;

FIG. 8 is a schematic view showing a positional relationship between the container and an inner cover in a state where the outer cover in the image forming apparatus according to the embodiment is in the open position;

FIG. 9 is a schematic view showing a positional relationship between the container and the inner cover in a state where the outer cover in the image forming apparatus according to the embodiment is in a closed position;

FIG. 10 is a perspective view of a development device in the image forming apparatus according to the embodiment;

FIG. 11 is an enlarged view of a toner reception unit in the development device shown in FIG. 10;

FIG. 12 is a perspective view of a toner supply unit in the container which is fitted into the image forming apparatus according to the embodiment (diagram in a state where a container shutter is in a blocking position);

FIG. 13 is a perspective view of the toner supply unit in the container which is fitted into the image forming apparatus according to the embodiment (diagram in a state where the container shutter is in an opening position);

FIG. 14 is a diagram in which a shutter mount and the container shutter are omitted from the toner supply unit shown in FIG. 13;

FIG. 15 is a perspective view of the container shutter in the container which is fitted into the image forming apparatus according to the embodiment;

FIG. 16 is a cross-sectional schematic view in a state where the container shutter in the container which is fitted into the image forming apparatus according to the embodiment is in the blocking position;

FIG. 17 is a cross-sectional schematic view in a state where the container shutter in the container which is fitted into the image forming apparatus according to the embodiment is in the opening position;

FIG. 18 is a cross-sectional schematic view showing the state of the container shutter when the outer cover in the image forming apparatus according to the embodiment is turned toward the closed position;

FIG. 19 is a cross-sectional schematic view showing the state of the container shutter when the outer cover in the image forming apparatus according to the embodiment reaches the closed position;

FIG. 20 is a cross-sectional schematic view showing the state of the container shutter when the outer cover in the image forming apparatus according to the embodiment has reached the closed position; and

FIG. 21 is a cross-sectional schematic view showing the state of the container shutter when the outer cover in the image forming apparatus according to the embodiment starts to be turned from the closed position toward the open position.

### DETAILED DESCRIPTION

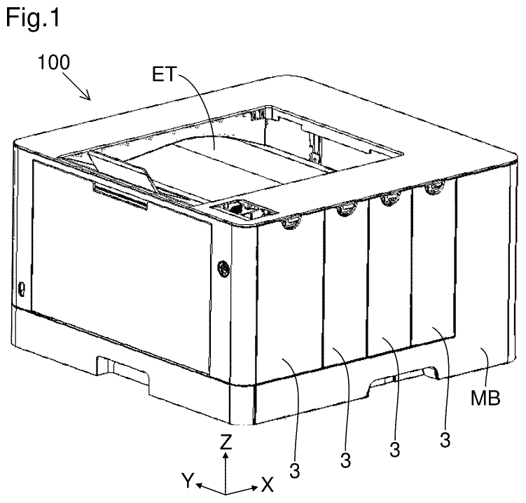

An image forming apparatus 100 in the present embodiment will be described below with reference to FIGS. 1 to 21. The image forming apparatus 100 is installed on a substantially horizontal, flat floor surface FL. A vertical direction perpendicular to the floor surface FL is an up/down direction in the image forming apparatus 100. One of horizontal directions is a forward/backward direction in the image forming apparatus 100, and the other direction orthogonal to the one direction is a left/right direction in the image forming apparatus 100.

In the drawings referenced in the following description, for ease of understanding, an XYZ Cartesian coordinate system is shown. A Z direction is the vertical direction which is the up/down direction in the image forming apparatus 100. The floor surface FL is a surface which is perpendicular to the Z direction. A direction indicated by the arrow of the Z direction is an upward direction, and a direction opposite thereto is a downward direction.

An X direction is one of the horizontal directions, and a Y direction is the other of the horizontal directions. For example, the X direction corresponds to the forward/backward direction in the image forming apparatus 100. The Y direction corresponds to the left/right direction in the image forming apparatus 100.

### Configuration of Image Forming Apparatus

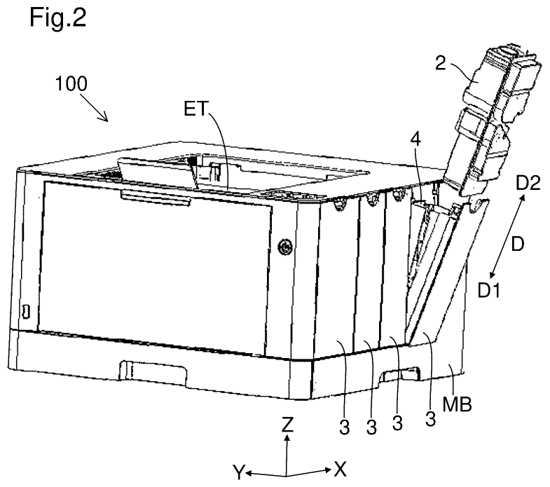

As shown in FIGS. 1 and 2, the image forming apparatus 100 includes a main body MB. The image forming apparatus 100 also includes containers 2. The containers 2 store toners used in printing. The containers 2 are fitted into the main body MB. The number of containers 2 fitted is four. The four containers 2 correspond to cyan, magenta, yellow and black. The containers 2 store the toners of the corresponding colors.

The containers 2 are removable from the main body MB. A user manually performs a fitting/removal operation on each of the containers 2. For example, when any one of the containers 2 is empty, the empty container 2 is removed, and a new container 2 is fitted.

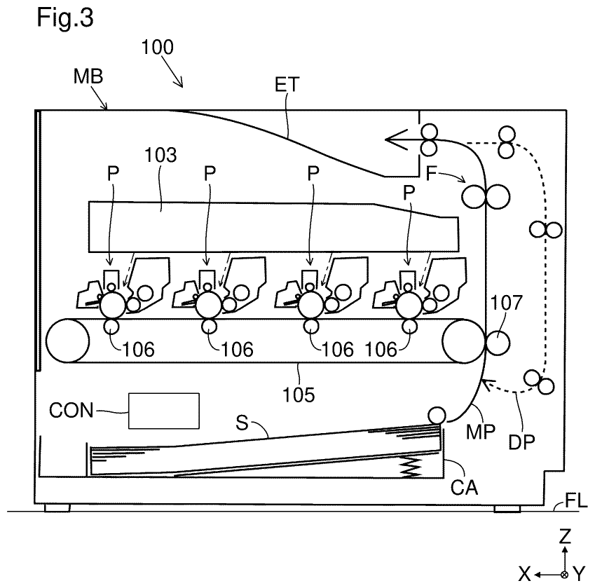

As shown in FIG. 3, the main body MB includes a sheet cassette CA. The sheet cassette CA is removably fitted into the main body MB. The sheet cassette CA stores sheets S used in printing. When printing is performed, the sheet S in the sheet cassette CA is supplied to a main conveyance path MP, and the sheet S is conveyed along the main conveyance path MP. The main conveyance path MP extends through a transfer position and a fixing position in this order, and reaches an ejection tray ET.

The main body MB includes four image formation units P corresponding to the colors of cyan, magenta, yellow and black. Each of the image formation units P uses the toner of the corresponding color to form an image.

Although attention is focused on one of the image formation units P, and its configuration will be described below, the configurations of the image formation units P are the same as each other. Hence, the following description can be used for the description of the configurations of the other image formation units P, and thus the description is omitted.

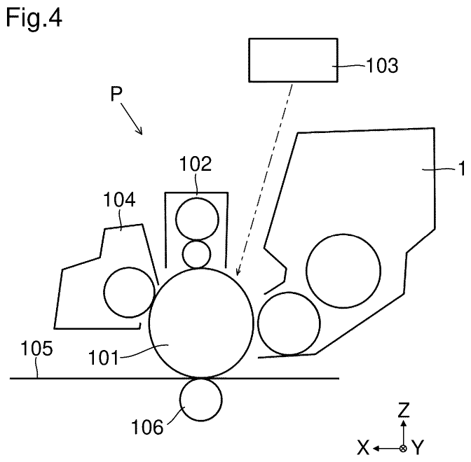

The image formation unit P has the configuration as shown in FIG. 4. The image formation unit P includes a development device 1. The image formation unit P also includes a photosensitive drum 101, a charging device 102, an exposure device 103 and a cleaning device 104.

The photosensitive drum 101 is supported rotatably around an axis extending in the left/right direction (Y direction). The photosensitive drum 101 is rotated while carrying a toner image on its outer circumferential surface. The charging device 102 charges the outer circumferential surface of the photosensitive drum 101. The exposure device 103 exposes the outer circumferential surface of the photosensitive drum 101 to form an electrostatic latent image on the outer circumferential surface of the photosensitive drum 101.

The development device 1 receives the supply of the toner of the corresponding color from the container 2, and stores the toner. The development device 1 uses the toner of the corresponding color to develop the electrostatic latent image on the outer circumferential surface of the photosensitive drum 101 into the toner image. The cleaning device 104 removes the toner left on the outer circumferential surface of the photosensitive drum 101.

As shown in FIG. 3, the main body MB includes an intermediate transfer belt 105. The intermediate transfer belt 105 is a seamless belt. The intermediate transfer belt 105 is stretched on a plurality of tension rollers (the symbols of which are omitted).

The intermediate transfer belt 105 is disposed such that its outer circumferential surface is in contact with the outer circumferential surface of each of the photosensitive drums 101. On the outer circumferential surface of the intermediate transfer belt 105, the toner images on the outer circumferential surfaces of the photosensitive drums 101 are primarily transferred. The intermediate transfer belt 105 is rotated while carrying the toner images on its outer circumferential surface. In this way, the toner images on the outer circumferential surface of the intermediate transfer belt 105 are conveyed toward the transfer position.

The main body MB includes primary transfer rollers 106. The four primary transfer rollers 106 are provided. The primary transfer rollers 106 are allocated to the photosensitive drums 101, respectively. Each of the primary transfer rollers 106 sandwiches the intermediate transfer belt 105 between the corresponding photosensitive drum 101 and the primary transfer roller 106.

The main body MB includes a secondary transfer roller 107. The secondary transfer roller 107 is pressed against the outer circumferential surface of the intermediate transfer belt 105 in the transfer position, and forms a transfer nip between the intermediate transfer belt 105 and the secondary transfer roller 107. The main conveyance path MP extends via the transfer nip.

In a print job, the sheet S is conveyed toward the transfer position (that is, the transfer nip). Each of the image formation units P uses the toner of the corresponding color to form the toner image. The primary transfer rollers 106 primarily transfer the toner images to the outer circumferential surface of the intermediate transfer belt 105. The intermediate transfer belt 105 is rotated while carrying the toner images. The secondary transfer roller 107 secondarily transfers the toner images to the sheet S which is being passed through the transfer position.

The main body MB includes a fixing unit F. The fixing unit F includes a heating roller and a pressure roller. The heating roller incorporates a heater. The pressure roller is pressed against the heating roller. The heating roller and the pressure roller are pressed against each other to form a fixing nip in the fixing position.

In the print job, the sheet S is passed through the fixing position (that is, the fixing nip). The fixing unit F heats the sheet S being passed through the fixing position, and pressurizes the sheet S. The fixing unit F heats and pressurizes the sheet S to fix the toner images on the sheet S. The sheet S on which the fixing processing has been performed is ejected to the ejection tray ET.

The image forming apparatus 100 includes a double-sided printing conveyance path DP. In this way, the image forming apparatus 100 can perform not only a single-sided print job for printing an image on only one side of the sheet S but also a double-sided print job for printing images on both sides of the sheet S.

The double-sided printing conveyance path DP branches from the main conveyance path MP in a branch position on a downstream side of the main conveyance path MP in a sheet conveyance direction with respect to the fixing position. The double-sided printing conveyance path DP merges into the main conveyance path MP in a merging position on an upstream side of the main conveyance path MP in the sheet conveyance direction with respect to the transfer position.

When a job to be performed is the single-sided print job, the sheet S is passed through the transfer position only once, and the transfer processing is performed on the sheet S being passed through the transfer position. Then, after the first transfer processing, the sheet S is ejected to the ejection tray ET without being processed.

When a job to be performed is the double-sided print job, the transfer processing is performed once on each of the front and back sides of the sheet S, and thus the sheet S is passed through the transfer position twice. Specifically, when the sheet S is passed through the transfer position for the first time, the transfer processing is performed on one side of the sheet S. After the first transfer processing, the sheet S is switched back after the back end of the sheet S is passed through the branch position and before the sheet S is completely ejected to the ejection tray ET. In this way, the sheet S is drawn from the back end into the double-sided printing conveyance path DP.

Thereafter, the sheet S is conveyed along the double-sided printing conveyance path DP, and the sheet S is returned from the merging position to the main conveyance path MP. In this way, the sheet S is passed through the transfer position again. Here, the orientation of the front and back sides of the sheet S is reversed from the orientation when the sheet S was passed through the transfer position the previous time. Consequently, when the sheet S is passed through the transfer position for the second time, the transfer processing is performed on the other side of the sheet S opposite to the one side of the sheet S.

### Mechanism for Holding Container

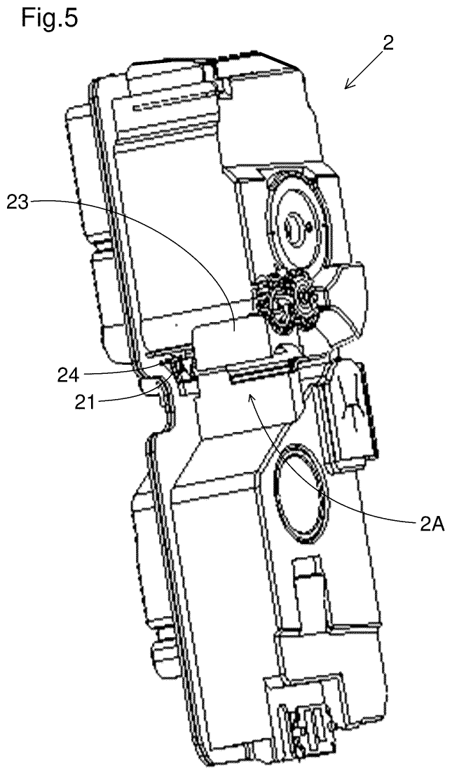

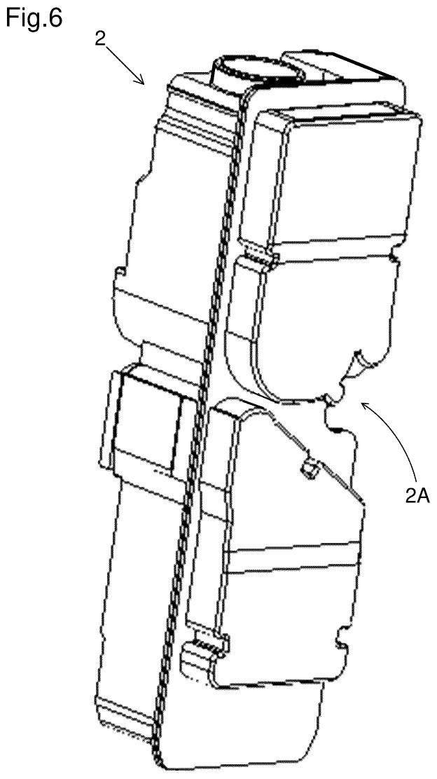

The container 2 has a configuration as shown in FIGS. 5 and 6. The side of the container 2 shown in FIG. 5 is directed to the inside of the main body MB, and the side of the container 2 shown in FIG. 6 is directed to the outside of the main body MB. The basic configurations of the containers 2 are the same as each other. The capacity of the container 2 for storing the toner of black may be larger than the capacities of the containers 2 for storing the toners of the other colors.

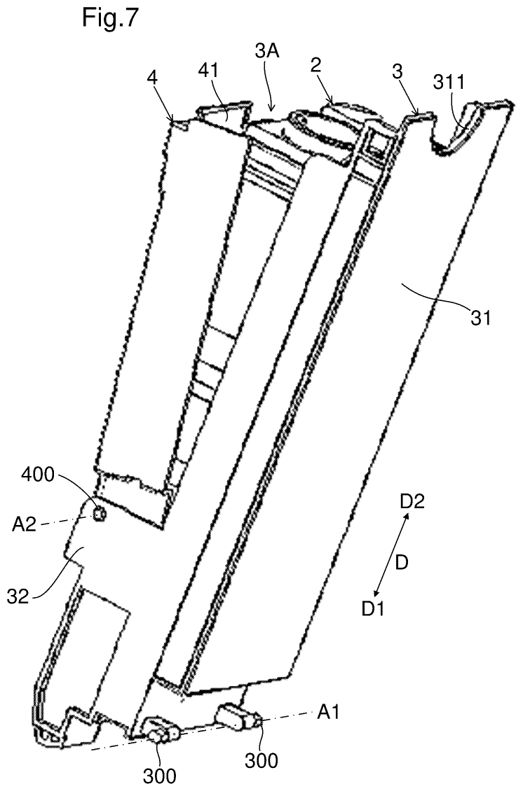

In order to hold the container 2, a mechanism as shown in FIG. 7 is used. The container 2 is held by an outer cover 3 and an inner cover 4. In other words, the image forming apparatus 100 includes the outer cover 3 and the inner cover 4. The outer cover 3 corresponds to a “cover”.

The mechanism shown in FIG. 7 is provided to each of the containers 2. In other words, the outer cover 3 is provided to each of the containers 2. The inner cover 4 is also provided to each of the containers 2.

The outer cover 3 is made of resin. The outer cover 3 may be made of sheet metal. The outer cover 3 is a part of an exterior which covers the interior of the main body MB from an outer side. In other words, the outer cover 3 includes an exterior surface 31.

The outer cover 3 is attached to the main body MB to be openable and closable. When the user performs the fitting/removal operation on the container 2, the outer cover 3 is manually opened and closed. For example, the outer cover 3 includes, as a handle 311, a part which is cut downward from the upper edge of the exterior surface 31. When the outer cover 3 is opened or closed, a finger of the user is placed on the handle 311.

The outer cover 3 is supported turnably around an outer cover axis A1 with respect to the main body MB. The outer cover 3 is turned around the outer cover axis A1 to be opened and closed. The outer cover axis A1 is an axis extending in the forward/backward direction (X direction). In other words, the outer cover axis A1 is an axis orthogonal to the up/down direction. The outer cover axis A1 corresponds to a “predetermined axis”.

The outer cover 3 includes a pair of support pins 300. The pair of support pins 300 are disposed on the outer cover axis A1, and extend in the axial direction of the outer cover axis A1. On the other hand, the main body MB includes a pair of support holes though the pair of support holes are not shown in the figure. The pair of support holes in the main body MB are disposed on the outer cover axis A1, and are opened in the axial direction of the outer cover axis A1. The pair of support pins 300 are fitted into the pair of support holes in the main body MB. The pair of support pins 300 are slidable around the outer cover axis A1 relative to the support holes into which the pair of support pins 300 are fitted. In this way, the outer cover 3 can be turned with the outer cover axis A1 serving as a support point.

The outer cover 3 includes a fitting region 3A on the back surface side of the exterior surface 31 (that is, the inner side of the main body MB). The container 2 is fitted into the fitting region 3A. The container 2 is removable from the fitting region 3A. The outer cover 3 is displaced around the outer cover axis A1, and thus it is possible to cause the cover 3 to reach positions in which the container 2 can be fitted and removed.

Specifically, the outer cover 3 is turned around the outer cover axis A1 to be displaceable between an open position and a closed position. The outer cover 3 is brought into a state where the outer cover 3 is opened in the open position, and is brought into a state where the outer cover 3 is closed in the closed position.

When the outer cover 3 is in the closed position, the interior of the main body MB is covered from the outer side. The fitting region 3A is placed inside the main body MB. In other words, the container 2 in the fitting region 3A is brought into a state where the container 2 is fitted inside the main body MB. The container 2 fitted inside the main body MB is brought into a state where the container 2 is covered by the outer cover 3 from the outer side of the main body MB.

In the state where the outer cover 3 is in the closed position (that is, in the state where the container 2 is fitted inside the main body MB), the container 2 is located inside the main body MB. The container 2 is connected to the development device 1. In this way, it is possible to supply the toner from the container 2 to the development device 1.

In a state where the outer cover 3 is in the open position, the interior of the main body MB is exposed. In other words, the container 2 in the fitting region 3A is exposed to the outside of the main body MB. In this way, the container 2 is removable from the fitting region 3A. When the outer cover 3 is in the open position, the container 2 is removable from the fitting region 3A.

A rotation angle between the open position and the closed position of the outer cover 3 about the outer cover axis A1 is less than 90°, and the outer cover 3 cannot be opened when the rotation angle is equal to or greater than 90°. Hence, the direction of fitting/removal D of the container 2 relative to the fitting region 3A is inclined with respect to the up/down direction and the horizontal direction. In other words, when the container 2 is fitted into the fitting region 3A, the container 2 is moved diagonally downward (in the direction of fitting D1). When the container 2 is removed from the fitting region 3A, the container 2 is moved diagonally upward (in the direction of removal D2).

The inner cover 4 is made of resin. The inner cover 4 may be made of sheet metal. The inner cover 4 covers the container 2 in the fitting region 3A from the inner side of the main body MB. In a state where the container 2 is fitted into the fitting region 3A, the container 2 is covered by the outer cover 3 from the outer side of the main body MB, and is covered by the inner cover 4 from the inner side of the main body MB. In other words, the container 2 is disposed between the outer cover 3 and the inner cover 4. Furthermore, in other words, a region between the outer cover 3 and the inner cover 4 is the fitting region 3A.

The inner cover 4 is supported turnably around an inner cover axis A2 with respect to the outer cover 3. The inner cover axis A2 is an axis extending in the forward/backward direction (X direction). In other words, the inner cover axis A2 is an axis parallel to the outer cover axis A1.

The inner cover 4 includes a pair of support pins 400. The pair of support pins 400 are disposed on the inner cover axis A2, and extend in the axial direction of the inner cover axis A2. On the other hand, the outer cover 3 includes a pair of support holes (the symbols of which are omitted). The pair of support holes in the outer cover 3 are disposed on the inner cover axis A2, and are opened in the axial direction of the inner cover axis A2. In the outer cover 3, the support holes are respectively formed in a pair of side walls 32 opposite each other in the forward/backward direction. The pair of support pins 400 are fitted into the pair of support holes in the outer cover 3. The pair of support pins 400 are slidable around the inner cover axis A2 relative to the support holes into which the pair of support pins 400 are fitted. In this way, the inner cover 4 can be turned with the inner cover axis A2 serving as a support point.

The inner cover 4 sandwiches, inside the main body MB, the container 2 in the fitting region 3A, between the outer cover 3 and an upper part 41 located above the inner cover axis A2. In the following description, the upper part 41 of the inner cover 4 is referred to as the inner cover upper part 41. The inner cover upper part 41 is displaced in conjunction with the turning of the outer cover 3 around the outer cover axis A1. In other words, the inner cover upper part 41 is displaced according to the position of the outer cover 3.

Specifically, the image forming apparatus 100 includes a torsion coil spring (not shown). The torsion coil spring is disposed in at least one of the pair of support pins 400. In other words, the torsion coil spring is disposed on the inner cover axis A2. Although not shown in the figure, one arm of the torsion coil spring engages with the outer cover 3, and the other arm engages with the inner cover 4. The inner cover 4 is biased by the biasing force of the torsion coil spring in a direction in which the inner cover upper part 41 is moved away from the outer cover 3.

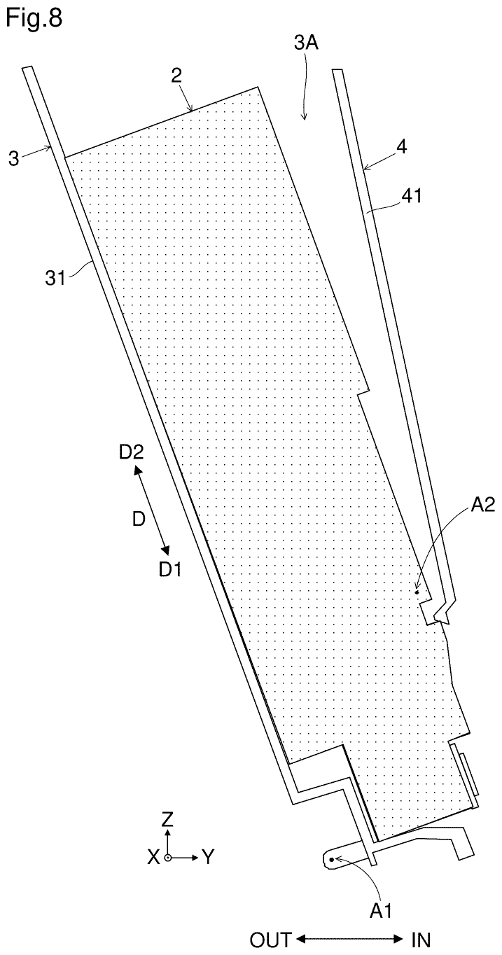

In the state where the outer cover 3 is in the open position, as shown in FIG. 8, the inner cover upper part 41 is moved away from the outer cover 3 to the maximum extent by the biasing force of the torsion coil spring. In other words, the fitting region 3A is opened. In this way, the container 2 is removable from the fitting region 3A.

When the container 2 is fitted into or removed from the fitting region 3A, the user moves the container 2 in the direction of fitting/removal D. Here, the inner cover upper part 41 functions as a guide. The inner cover upper part 41 guides the movement of the container 2 in the direction of fitting/removal D. When the container 2 is fitted into the fitting region 3A, the user closes the outer cover 3. In other words, the outer cover 3 is turned from the open position to the closed position.

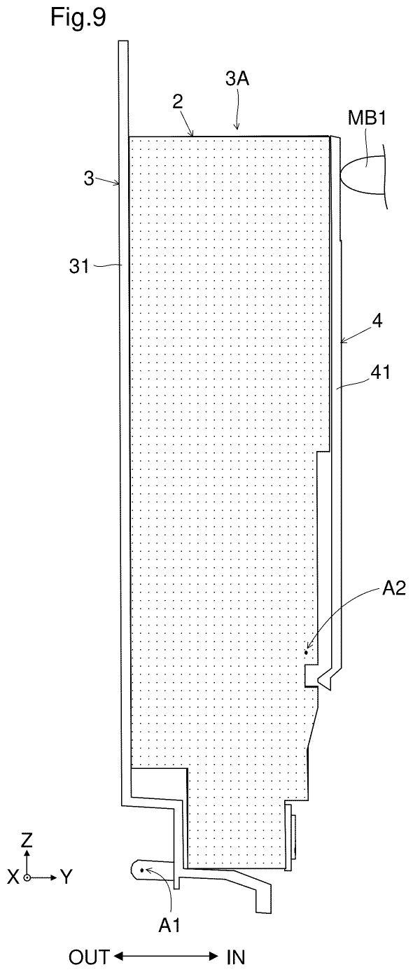

When the outer cover 3 is turned from the open position toward the closed position, and thus the inner cover upper part 41 enters the main body MB, a main body member MB1 (see FIG. 9) disposed inside the main body MB makes contact with the inner cover upper part 41. Thereafter, when the outer cover 3 continues to be turned from the open position toward the closed position, the main body member MB1 presses the inner cover upper part 41 from the inner side of the main body MB to the outer side thereof. Here, the inner cover upper part 41 is turned around the inner cover axis A2, and thus the inner cover upper part 41 is displaced against the biasing force of the torsion coil spring in a direction in which the inner cover upper part 41 approaches the container 2 in the fitting region 3A.

In the state where the outer cover 3 is in the closed position, as shown in FIG. 9, the pressing of the inner cover upper part 41 performed by the main body member MB1 is maintained. In this way, the container 2 in the fitting region 3A is sandwiched between the outer cover 3 and the inner cover upper part 41.

When in the state shown in FIG. 9, the outer cover 3 is turned toward the open position, the inner cover upper part 41 is turned around the outer cover axis A1 together with the outer cover 3, and thus the inner cover upper part 41 is displaced in a direction in which the inner cover upper part 41 is moved away from the main body member MB1. Finally, the contact between the main body member MB1 and the inner cover upper part 41 is released. Furthermore, the inner cover upper part 41 is turned around the inner cover axis A2 by the biasing force of the torsion coil spring, and thus the inner cover upper part 41 is displaced in the direction in which the inner cover upper part 41 is moved away from the outer cover 3. This results in a state shown in FIG. 8.

Here, the four outer covers 3 corresponding to the four containers 2 of cyan, magenta, yellow and black are displaceable between the open position and the closed position independently of each other. Each of the outer covers 3 is turned from the open position to reach the closed position in a state where the corresponding container 2 is fitted into the fitting region 3A, and thus the corresponding container 2 is brought into a state where the corresponding container 2 is fitted inside the main body MB.

In FIGS. 8 and 9, a dot pattern is provided to the container 2 to clarify the container 2. In FIGS. 8 and 9, the side indicated by an arrow “IN” is the inner side of the main body MB, and the side indicated by an arrow “OUT” is the outer side of the main body MB.

### Mechanism for Supplying Toner

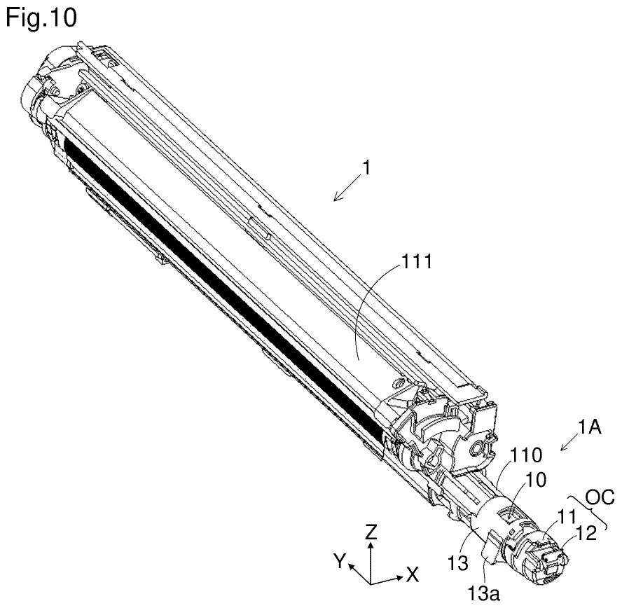

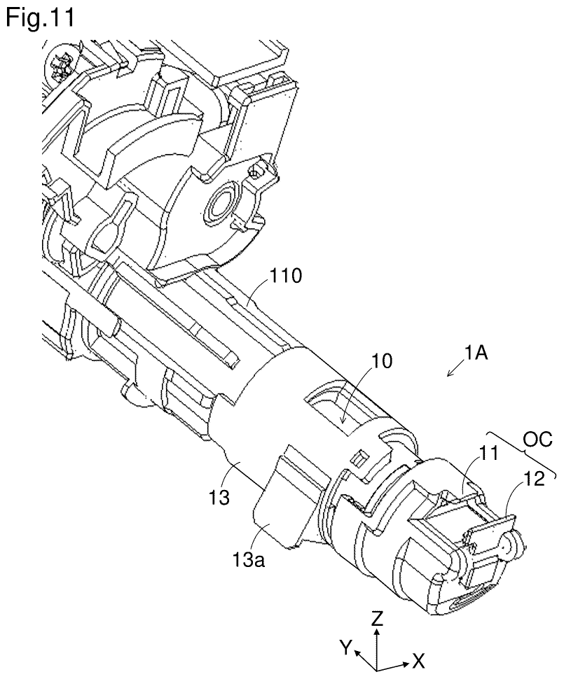

As shown in FIGS. 10 and 11, the development device 1 includes a toner reception unit 1A. The container 2 includes a toner supply unit 2A (see FIGS. 5 and 6). The container 2 is fitted into the main body MB, and thus the toner supply unit 2A is connected to the toner reception unit 1A. In this state, the toner can flow between the toner supply unit 2A and the toner reception unit 1A. In this way, the toner can be supplied from the container 2 into the development device 1.

The development device 1 includes a development container 111 in which the left/right direction (Y direction) is its longitudinal direction. The development container 111 stores the toner supplied from the container 2 inside the development container 111. Inside the development container 111, a stirring screw, a development roller and the like are disposed. The stirring screw is rotated to convey the toner while stirring the toner. The development roller is rotated while carrying the toner stirred by the stirring screw on its outer circumferential surface. The development device 1 supplies the toner on the development roller to the photosensitive drum 101.

The toner reception unit 1A includes a cylindrical member 110 which protrudes in a substantially cylindrical shape from the development container 111 to one side in the left/right direction. The cylindrical member 110 protrudes toward the outer side of the main body MB. The interiors of the cylindrical member 110 and the development container 111 communicate with each other.

In the following description, the center axis of the cylindrical member 110 is referred to as a cylinder center axis. A direction in which the cylinder center axis extends is simply referred to as the axial direction, the radial direction of a circle with the cylinder center axis in the center is simply referred to as the radial direction and the circumferential direction of the circle with the cylinder center axis in the center is simply referred to as the circumferential direction. The axial direction is the left/right direction (Y direction).

The cylindrical member 110 includes a reception port 10. The reception port 10 is opened upward (that is, in the radial direction). The reception port 10 communicates with the interior of the cylindrical member 110. The toner supplied from the container 2 flows into the cylindrical member 110 via the reception port 10.

The cylindrical member 110 has its interior as a toner flow path. Inside the cylindrical member 110, a part of the stirring screw is disposed. The toner inside the cylindrical member 110 is stirred and conveyed by the stirring screw to reach the development container 111. In other words, the toner is moved in the axial direction inside the cylindrical member 110.

Here, the toner reception unit 1A includes a shutter opening/closing mechanism OC. In other words, the image forming apparatus 100 includes the shutter opening/closing mechanism OC which is disposed inside the main body MB. Furthermore, in other words, the shutter opening/closing mechanism OC is disposed in the development device 1. The shutter opening/closing mechanism OC is a mechanism for opening and closing a container shutter 21 which will be described later. The shutter opening/closing mechanism OC includes a first engagement portion 11 and a second engagement portion 12.

The first engagement portion 11 is disposed above the outer circumferential surface of the cylindrical member 110. For example, a member which includes the first engagement portion 11 is disposed on the outer circumferential surface of the cylindrical member 110. The member includes, as the first engagement portion 11, the tip end side (the outer side of the main body MB) of a part which extends in the axial direction above the outer circumferential surface of the cylindrical member 110.

The second engagement portion 12 is disposed above the outer circumferential surface of the cylindrical member 110 and on the outer side of the main body MB with respect to the first engagement portion 11. The first engagement portion 11 and the second engagement portion 12 are spaced opposite each other in the axial direction. For example, in a tip end portion of the cylindrical member 110 on the outer side of the main body MB, a plate-shaped member which protrudes above the outer circumferential surface of the cylindrical member 110 is disposed. An upper end portion of the plate-shaped member serves as the second engagement portion 12.

The shutter opening/closing mechanism OC brings the first engagement portion 11 and the second engagement portion 12 into contact with the container shutter 21 which will be described later to open and close the container shutter 21. The details thereof will be described later.

The toner reception unit 1A includes a rotation shutter 13. The rotation shutter 13 is substantially cylindrical, and is disposed on the outer circumferential surface of the cylindrical member 110. The rotation shutter 13 is slidable in the circumferential direction with respect to the cylindrical member 110. However, the rotation shutter 13 is biased to one side in the circumferential direction by an unillustrated biasing member (hereinafter referred to as the rotation shutter biasing member).

The rotation shutter 13 includes an opening (the symbol of which is omitted). The opening of the rotation shutter 13 (hereinafter referred to as the rotation shutter opening) is opened in the radial direction. The rotation shutter 13 slides in the circumferential direction to be displaceable between a position where the reception port 10 is blocked and a position where the reception port 10 and the rotation shutter opening overlap each other in the radial direction.

When a force against the biasing force of the rotation shutter biasing member is not generated, the rotation shutter 13 blocks the reception port 10. When the container 2 is not fitted inside the main body MB, the reception port 10 is blocked.

On the other hand, when a force against the biasing force of the rotation shutter biasing member is generated, the rotation shutter 13 is displaced in the circumferential direction, and thus the reception port 10 and the rotation shutter opening overlap each other in the radial direction. In other words, the rotation shutter 13 is opened so as not to block the reception port 10. The container 2 is fitted into the main body MB, and thus the reception port 10 is opened.

For example, the rotation shutter 13 includes a pressed portion 13a in the outer circumferential surface. A force which presses the pressed portion 13a in a tangential direction is generated, and thus the rotation shutter 13 is displaced against the biasing force of the rotation shutter biasing member.

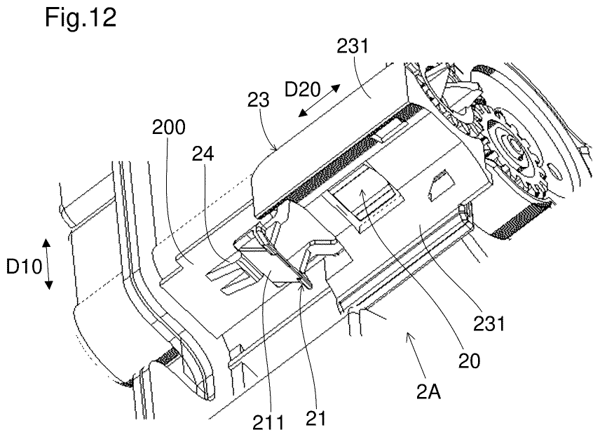

On the other hand, the toner supply unit 2A has a configuration as shown in FIGS. 12 to 14. The toner supply unit 2A includes a supply region (the symbol of which is omitted). The supply region is a region which penetrates in the left/right direction (Y direction) in a state where the container 2 is fitted inside the main body MB. In the state where the container 2 is fitted inside the main body MB, the toner reception unit 1A is disposed in the supply region of the toner supply unit 2A.

The toner supply unit 2A includes a supply port 20. The supply port 20 is located above the reception port 10 in the state where the container 2 is fitted inside the main body MB, and is opened downward. In the following description, a direction in which the supply port 20 is opened is identified with a symbol D10, and is referred to as a first direction D10 whereas a direction orthogonal to the first direction D10 is identified with a symbol D20, and is referred to as a second direction D20. In the state where the container 2 is fitted inside the main body MB, the first direction D10 is the up/down direction (Z direction), and the second direction D20 is the left/right direction (Y direction).

In the state where the container 2 is fitted inside the main body MB, the supply port 20 overlaps the reception port 10 in the up/down direction. In this way, in the state where the container 2 is fitted inside the main body MB, the supply port 20 causes the toner in the container 2 to flow to the development device 1. In other words, the container 2 is fitted into the main body MB, and thus the toner can be supplied from the container 2 into the development device 1.

For example, the main body container of the container 2 includes an opening (hereinafter referred to as the container opening). The container opening is blocked by a base member 200. However, the base member 200 includes an opening which penetrates in the first direction D10. Hence, the toner inside the container 2 can be caused to flow out via the opening of the base member 200. In this configuration, the opening of the base member 200 is the supply port 20

The toner supply unit 2A includes the container shutter 21. The container shutter 21 corresponds to a “shutter”. The container shutter 21 is a member which can be elastically deformed. The container shutter 21 is, for example, a resin molded product.

The container shutter 21 is disposed below the base member 200. In other words, the container shutter 21 is disposed below the supply port 20. The container shutter 21 is supported slidably in the second direction D20.

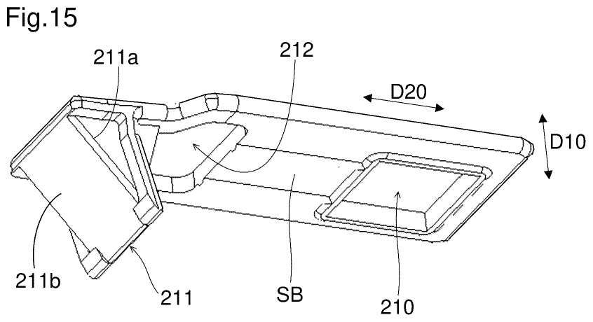

A diagram of the container shutter 21 alone is shown in FIG. 15. The container shutter 21 includes an opening 210 in a shutter base SB. The shutter base SB is formed substantially in the shape of a plate in which the second direction D20 is its longitudinal direction and the first direction D10 is its thickness direction. The opening 210 is disposed on one end side of both ends of the shutter base SB in the second direction D20. The opening 210 penetrates the shutter base SB in the first direction D10.

The container shutter 21 slides in the second direction D20 to be displaceable between a blocking position and an opening position. The opening 210 is displaced in the second direction D20 to block and open the supply port 20.

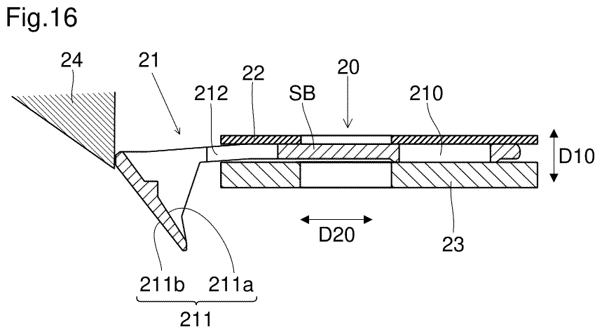

The position of the container shutter 21 shown in FIGS. 12 and 16 is the blocking position. In a state where the container shutter 21 is in the blocking position, the container shutter 21 blocks the supply port 20 from below. In this way, in the state where the container shutter 21 is in the blocking position, the flowing out of the toner from the interior of the container 2 to the outside thereof is suppressed. FIG. 16 is a diagram schematically showing a cross-sectional structure of the toner supply unit 2A taken along a plane parallel to both the first direction D10 and the second direction D20.

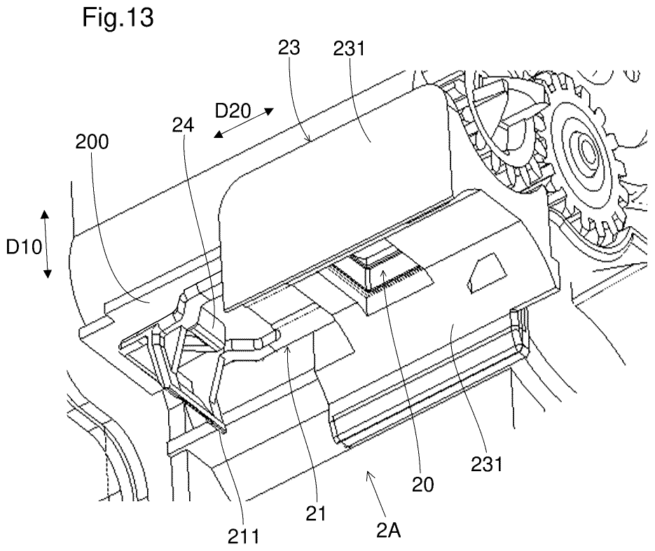

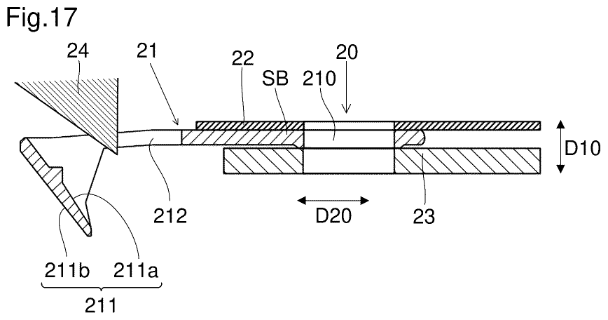

The position of the container shutter 21 shown in FIGS. 13 and 17 is the opening position. In a state where the container shutter 21 is in the opening position, the container shutter 21 opens the supply port 20. Specifically, in the state where the container shutter 21 is in the opening position, the supply port 20 and the opening 210 overlap each other in the first direction D10. In this way, it is possible to cause the toner to flow out from the interior of the container 2 to the outside thereof. In other words, it is possible to supply the toner from the container 2 (the toner supply unit 2A) into the development device 1 (the toner reception unit 1A). FIG. 17 is a diagram schematically showing a cross-sectional structure of the toner supply unit 2A taken along the plane parallel to both the first direction D10 and the second direction D20.

The container shutter 21 includes a shutter engagement portion 211. The shutter engagement portion 211 is disposed on the other end side of both ends of the shutter base SB in the second direction D20 (that is, on the side opposite to the side on which the opening 210 is disposed). The shutter engagement portion 211 extends downward from the other edge of the shutter base SB in the second direction D20. The shutter engagement portion 211 is inclined diagonally downward from the other end side of the shutter base SB in the second direction D20 toward the one end side when viewed in the forward/backward direction (direction orthogonal to both the first direction D10 and the second direction D20).

Since the shutter engagement portion 211 is inclined diagonally downward from the other end side of the shutter base SB in the second direction D20 toward the one end side, the shutter engagement portion 211 includes a first inclination surface 211a and a second inclination surface 211b. In the state where the container 2 is fitted inside the main body MB, the first inclination surface 211a is directed to the inner side of the main body MB, and the second inclination surface 211b is directed to the outer side of the main body MB. Furthermore, when viewed in the forward/backward direction (which corresponds to the “axial direction of the predetermined axis”), each of the first inclination surface 211a and the second inclination surface 211b is inclined diagonally downward from the outer side of the main body MB toward the inner side.

The container shutter 21 includes an escape portion 212. The escape portion 212 is an opening which penetrates the shutter base SB in the first direction D10. The escape portion 212 is disposed on the other end side of the shutter base SB in the second direction D20 (that is, on the side on which the shutter engagement portion 211 is disposed). The opening serving as the escape portion 212 reaches the other edge of the shutter base SB in the second direction D20. In this way, the other end side of the shutter base SB in the second direction D20 is easily elastically deformed. The escape portion 212 is the opening for causing a stopper 24 which will be described later to escape.

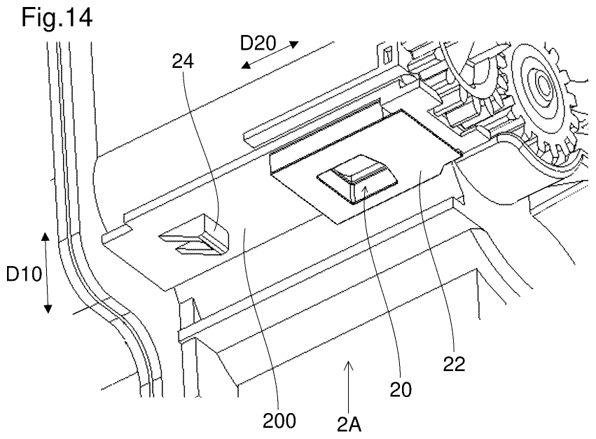

The toner supply unit 2A includes a seal member 22. The seal member 22 is a member which can be elastically deformed. The seal member 22 is disposed between the outer edge portion of the supply port 20 and the container shutter 21 in the first direction D10. In other words, the seal member 22 is disposed between the base member 200 and the container shutter 21 in the first direction D10. The position where the seal member 22 is disposed is shown in FIG. 14. In FIG. 14, members located below the seal member 22 are omitted so that the seal member 22 is clarified.

The seal member 22 is compressed in the first direction D10 between the outer edge portion of the supply port 20 and the container shutter 21 in the first direction D10. In this way, the seal member 22 seals a gap between the outer edge portion of the supply port 20 and the container shutter 21 in the first direction D10. The seal member 22 is disposed between the outer edge portion of the supply port 20 and the container shutter 21 in the first direction D10, and thus it is possible to suppress the leakage of the toner from between the outer edge portion of the supply port 20 and the container shutter 21 in the first direction D10.

The seal member 22 is a sheet-shaped member in which the first direction D10 is its thickness direction, and includes an opening (the symbol of which is omitted) which penetrates in the first direction D10. The opening of the seal member 22 is disposed to overlap the supply port 20 in the first direction D10. In this way, the seal member 22 is disposed between the outer edge portion of the supply port 20 and the container shutter 21 in the first direction D10.

The toner supply unit 2A includes a shutter mount 23. The shutter mount 23 includes at least a part which is disposed below the seal member 22. In the shutter mount 23, an opening (the symbol of which is omitted) which penetrates in the first direction D10 is formed. The shutter mount 23 is disposed in a position where its opening overlaps the supply port 20 in the up/down direction.

The shutter mount 23 sandwiches the container shutter 21 between the seal member 22 and the shutter mount 23 in the first direction D10. In this way, the sliding of the container shutter 21 in the second direction D20 is guided.

The shutter mount 23 is formed substantially in the shape of the letter U which is directed downward when viewed in the second direction D20. In other words, the shutter mount 23 includes a pair of side walls 231 which are opposite each other in the direction orthogonal to both the first direction D10 and the second direction D20. In a region sandwiched between the pair of side walls 231, the supply port 20 is connected to the reception port 10. Hence, in the following description, the region sandwiched between the pair of side walls 231 is referred to as the connection region. In FIGS. 16 and 17, for convenience, the pair of side walls 231 are omitted.

The container 2 is fitted into the main body MB, and thus the reception port 10 of the toner reception unit 1A and an area around the reception port 10 are disposed in the connection region. At least the rotation shutter 13 is disposed in the connection region. When the rotation shutter 13 is disposed in the connection region, one of the inner surfaces of the pair of side walls 231 makes contact with the pressed portion 13a of the rotation shutter 13, and thus the rotation shutter 13 is turned in a direction against the biasing force of the rotation shutter biasing member. In this way, the reception port 10 is opened.

The toner supply unit 2A includes the stopper 24. The stopper 24 is provided in the base member 200. The stopper 24 protrudes downward from the base member 200. In other words, the stopper 24 protrudes downward from above the container shutter 21. In this way, the stopper 24 is opposite the shutter engagement portion 211 in the second direction D20, and thereby can engage with the shutter engagement portion 211 in the second direction D20.

When the container shutter 21 is in the blocking position, the shutter engagement portion 211 makes contact with the stopper 24 in the second direction D20 to restrict the sliding of the container shutter 21 from the blocking position to the opening position (see FIGS. 12 and 16). In this way, it is possible to suppress the unintentional opening of the supply port 20.

### Behavior of Container Shutter

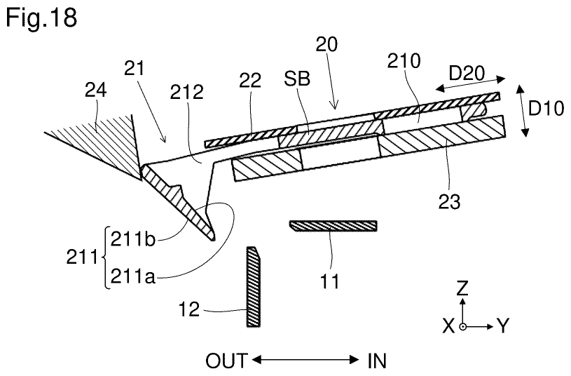

The behavior of the container shutter 21 when the container shutter 21 is opened and closed will be described below with reference to FIGS. 18 to 21. In the drawings referenced in the following description, for convenience, the pair of side walls 231 in the shutter mount 23 are omitted. For the toner reception unit 1A, only the first engagement portion 11 and the second engagement portion 12 are shown in the figures.

FIGS. 18 to 21 are diagrams schematically showing a cross-sectional structure of the toner supply unit 2A and an area around the toner supply unit 2A taken along the plane (that is, a YZ plane) parallel to both the first direction D10 and the second direction D20. In FIGS. 18 to 21, the side indicated by an arrow “IN” is the inner side of the main body MB, and the side indicated by an arrow “OUT” is the outer side of the main body MB.

When the container 2 is not fitted into the main body MB, the stopper 24 restricts the sliding of the container shutter 21 in the second direction D20. In this way, the container shutter 21 is held in the blocking position.

When the container 2 is fitted into the main body MB, the outer cover 3 is opened, and the container 2 is fitted into the fitting region 3A of the outer cover 3. Then, in such a state, the outer cover 3 is closed. In other words, the outer cover 3 is turned from the open position toward the closed position. At the start of the turning of the outer cover 3 from the open position toward the closed position, the container shutter 21 remains held in the blocking position.

After the start of the turning of the outer cover 3 from the open position to the closed position, a state shown in FIG. 18 is reached. In other words, the shutter engagement portion 211 approaches the second engagement portion 12 from the outer side of the main body MB. When the outer cover 3 is turned from the open position to the closed position, if the container shutter 21 is held in the blocking position, the shutter engagement portion 211 is passed above the second engagement portion 12.

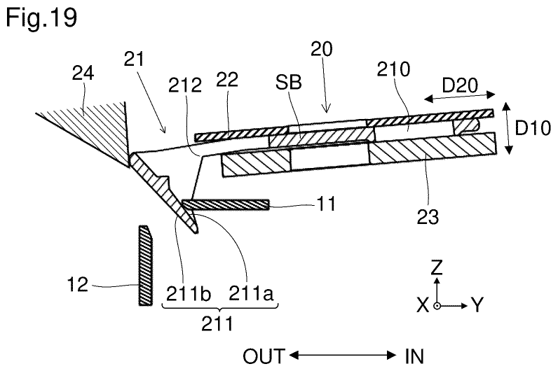

When the outer cover 3 is turned from the open position to reach the closed position, a state shown in FIG. 19 is reached. Specifically, the first engagement portion 11 makes contact with the shutter engagement portion 211 from the inner side of the main body MB. In other words, the first engagement portion 11 presses the shutter engagement portion 211 from the inner side of the main body MB toward the outer side. In this way, the first engagement portion 11 causes the container shutter 21 to slide from the blocking position toward the opening position in the second direction D20.

Here, the first engagement portion 11 makes contact with the first inclination surface 211a of the shutter engagement portion 211 from the inner side of the main body MB. Hence, the shutter engagement portion 211 is displaced downward along the first inclination surface 211a. In other words, the shutter engagement portion 211 is elastically deformed downward. Specifically, the other end side of the shutter base SB of the container shutter 21 in the second direction D20 is elastically deformed downward. Then, the shutter engagement portion 211 is elastically deformed downward to ride over the stopper 24 from below.

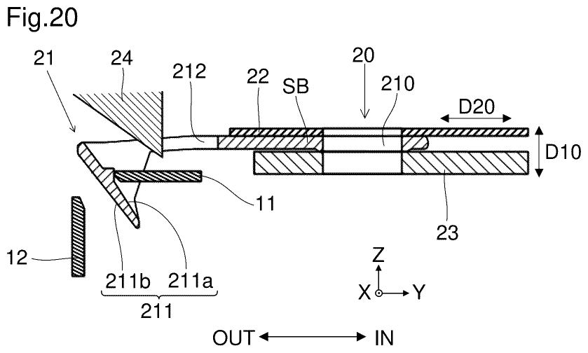

When the container shutter 21 reaches the opening position, that is, when the outer cover 3 reaches the closed position, a state shown in FIG. 20 is reached. The outer cover 3 reaches the closed position, and thus the container 2 is fitted inside the main body MB. In this state, the supply port 20 is opened downward, the supply port 20 is disposed above the reception port 10 and thus the supply port 20 and the reception port 10 overlap each other in the up/down direction (first direction D10). In this way, the supply port 20 communicates with the reception port 10. Consequently, the toner can be supplied from the container 2 into the development device 1.

In a state where the container shutter 21 reaches the opening position, the stopper 24 is disposed in the escape portion 212. The stopper 24 protrudes downward from the escape portion 212. In this way, it is possible to suppress the sliding of the container shutter 21 from the opening position toward the blocking position in the second direction D20.

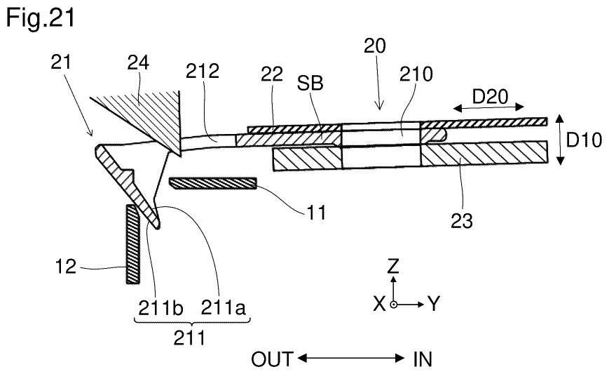

On the other hand, when the outer cover 3 starts to be turned from the closed position to the open position, a state shown in FIG. 21 is reached. Specifically, the second engagement portion 12 makes contact with the shutter engagement portion 211 from the outer side of the main body MB. In other words, the second engagement portion 12 presses the shutter engagement portion 211 from the outer side of the main body MB toward the inner side. In this way, the second engagement portion 12 causes the container shutter 21 to slide from the opening position toward the blocking position in the second direction D20.

Here, the second engagement portion 12 makes contact with the second inclination surface 211b of the shutter engagement portion 211 from the outer side of the main body MB. Hence, the shutter engagement portion 211 is displaced downward along the second inclination surface 211b. In other words, the shutter engagement portion 211 is elastically deformed downward. Specifically, the other end side of the shutter base SB of the container shutter 21 in the second direction D20 is elastically deformed downward. Then, the shutter engagement portion 211 is elastically deformed downward to ride over the stopper 24 from below.

Thereafter, the outer cover 3 continues to be turned from the closed position to the open position, and thus the state shown in FIG. 18 is reached, with the result that the outer cover 3 reaches the open position. When the outer cover 3 reaches the open position, the container shutter 21 remains held in the blocking position. Hence, in the state where the container shutter 21 is in the blocking position, the container 2 in the fitting region 3A of the outer cover 3 is removed.

In the present embodiment, when the container 2 is fitted into the main body MB, the first engagement portion 11 makes contact with the container shutter 21 which is being turned with the predetermined axis (that is, the outer cover axis A1) serving as a support point, and thus the container shutter 21 slides from the blocking position to the opening position. Here, the container shutter 21 slides on the seal member 22.

Here, if the container 2 (that is, the container shutter 21) is inserted into the main body MB in the horizontal direction, the container shutter 21 is unlikely to slide due to sliding resistance between the container shutter 21 and the seal member 22.

On the other hand, when the container 2 is turned toward the interior of the main body MB with the predetermined axis serving as a support point, as compared with the case where the container 2 is inserted into the main body MB in the horizontal direction, the container shutter 21 can be caused to slide from the blocking position toward the opening position with a smaller force. Consequently, it is possible to easily fit the container 2 into the main body MB while suppressing the leakage of the toner from the container 2.

In the present embodiment, when the container shutter 21 is caused to slide from the opening position toward the blocking position, the container 2 is turned with the predetermined axis (that is, the outer cover axis A1) serving as a support point, and thus the container shutter 21 is brought into contact with the second engagement portion 12 of the shutter engagement portion 211, with the result that the container shutter 21 is pressed. In this way, as in the case where the container shutter 21 is caused to slide from the blocking position toward the opening position, the container shutter 21 can be caused to slide from the opening position toward the blocking position with a smaller force.

In the present embodiment, when the container shutter 21 is caused to slide from the blocking position toward the opening position, the first engagement portion 11 makes contact with the first inclination surface 211a of the shutter engagement portion 211 from the inner side of the main body MB. In this way, even when the sliding of the container shutter 21 is restricted by the stopper 24, the shutter engagement portion 211 is easily elastically deformed downward, and thus the container shutter 21 can be caused to slide from the blocking position toward the opening position with a smaller force.

In the present embodiment, when the container shutter 21 is caused to slide from the opening position toward the blocking position, the second engagement portion 12 makes contact with the second inclination surface 211b of the shutter engagement portion 211 from the outer side of the main body MB. In this way, even when the sliding of the container shutter 21 is restricted by the stopper 24, the shutter engagement portion 211 is easily elastically deformed downward, and thus the container shutter 21 can be caused to slide from the opening position toward the blocking position with a smaller force.

In the present embodiment, the shutter opening/closing mechanism OC is disposed in the development device 1. Specifically, the first engagement portion 11 and the second engagement portion 12 serve as the shutter opening/closing mechanism OC. In this way, the configuration of the shutter opening/closing mechanism OC can be simplified.

The embodiment disclosed herein should be considered to be illustrative in all respects and not restrictive. The scope of the present disclosure is indicated not by the description of the embodiment but by the scope of claims, and furthermore, meanings equivalent to the scope of claims and all changes in the scope are included therein.

What is claimed is:

1. An image forming apparatus comprising:
a main body inside which a development device that develops an electrostatic latent image into a toner image is disposed;
a container that is removably fitted into the main body and stores a toner supplied into the development device; and
a cover that
is supported turnably around a predetermined axis orthogonal to an up/down direction with respect to the main body,
includes a fitting region into which the container is fitted and is displaceable between
an open position where the cover is turned around the predetermined axis to expose the container in the fitting region to an outside of the main body and
a closed position where the container in the fitting region is fitted inside the main body,
wherein the container includes:
a supply port that is opened downward in a state where the container is fitted inside the main body to cause the toner to flow to the development device;
a shutter that
is slidable in a second direction orthogonal to a first direction, the first direction being a direction in which the supply port is opened,
includes an opening that penetrates in the first direction and is displaceable between
a blocking position where the shutter slides in the second direction to block the supply port and
an opening position where the supply port overlaps the opening in the first direction; and
a seal member that seals a gap between an outer edge portion of the supply port and the shutter in the first direction,
in a state where the cover inside which the container is fitted is in the open position, the shutter is held in the blocking position whereas in a state where the cover inside which the container is fitted is in the closed position, the shutter is held in the opening position,
the image forming apparatus further comprises a shutter opening/closing mechanism that is disposed inside the main body,
the shutter includes a shutter engagement portion that protrudes in the first direction,
the shutter opening/closing mechanism includes a first engagement portion and
when the cover is turned from the open position to reach the closed position, the first engagement portion makes contact with the shutter engagement portion from an inner side of the main body to cause the shutter to slide from the blocking position toward the opening position in the second direction.

2. The image forming apparatus according to claim 1,
wherein the shutter opening/closing mechanism includes a second engagement portion, and
when the cover starts to be turned from the closed position to the open position, the second engagement portion makes contact with the shutter engagement portion from an outer side of the main body to cause the shutter to slide from the opening position toward the blocking position in the second direction.

3. The image forming apparatus according to claim 1,
wherein the container includes a stopper that protrudes downward from above the shutter,
when the shutter is in the blocking position, the shutter engagement portion makes contact with the stopper in the second direction to restrict the sliding of the shutter to the opening position and
when the cover is turned from the open position to reach the closed position, the first engagement portion makes contact with the shutter engagement portion from the inner side of the main body to elastically deform the shutter engagement portion downward and to cause the shutter engagement portion to ride over the stopper such that the shutter slides from the blocking position to reach the opening position.

4. The image forming apparatus according to claim 3,
wherein the shutter engagement portion includes a first inclination surface,
when the cover is turned from the open position to reach the closed position, the first engagement portion makes contact with the first inclination surface and
the first inclination surface is inclined diagonally downward from an outer side of the main body toward the inner side thereof when viewed in an axial direction of the predetermined axis.

5. The image forming apparatus according to claim 2,
wherein the container includes a stopper that protrudes downward from above the shutter,
when the shutter is in the blocking position, the shutter engagement portion makes contact with the stopper in the second direction to restrict the sliding of the shutter to the opening position,
when the cover is turned from the open position to reach the closed position, the first engagement portion makes contact with the shutter engagement portion from the inner side of the main body to elastically deform the shutter engagement portion downward and to cause the shutter engagement portion to ride over the stopper such that the shutter slides from the blocking position to reach the opening position and
when the cover starts to be turned from the closed position to the open position, the second engagement portion makes contact with the shutter engagement portion from the outer side of the main body to elastically deform the shutter engagement portion downward and to cause the shutter engagement portion to ride over the stopper such that the shutter slides from the opening position to reach the blocking position.

6. The image forming apparatus according to claim 5,
wherein the shutter engagement portion includes a second inclination surface,
the cover starts to be turned from the closed position to the open position, the second engagement portion makes contact with the second inclination surface and the second inclination surface is inclined diagonally downward from the outer side of the main body toward the inner side thereof when viewed in an axial direction of the predetermined axis.

7. The image forming apparatus according to claim 1,
wherein the shutter opening/closing mechanism is disposed in the development device.
